(19) United States
(12) Patent Application Publication
(10) Pub. No.: US 2024/0380795 A1
(43) Pub. Date: Nov. 14, 2024

(54) PROVIDING COMMUNICATION SESSIONS BASED ON MOBILE APPLICATION ENGAGEMENT

(71) Applicant: Viasat, Inc., Carlsbad, CA (US)

(72) Inventors: Fergal MURRAY, Tomhaggard (IE); Micheal Gregory SOLOMON, Ballyleague (IE)

(21) Appl. No.: 18/692,519

(22) PCT Filed: Sep. 16, 2022
(86) PCT No.: PCT/US2022/043873

§ 371 Date: Mar. 15, 2024

Related U.S. Application Data
(60) Provisional application No. 63/245,493, filed on Sep. 17, 2021.

(51) Int. Cl. H04L 65/1069; G06Q 30/0207; H04L 47/10; H04L 65/80; H04W 28/02; H04W 84/12

(52) U.S. Cl. CPC H04L 65/1069; G06Q 30/0239; H04L 47/13; H04L 65/80; H04W 28/0215; H04W 84/12

(57) ABSTRACT

Methods, systems, and devices for providing communication sessions based on mobile application engagement. In some examples, a communication session delivery system may establish, by a multi-user access terminal on a transport vessel, a communication session with a personal electronic device of a passenger, the communication session restricted to a first domain. The communication session delivery system may present, one or more reward offers related to the communication session and receive an indication of selection of a first reward offer associated with engagement of an application for execution on the personal electronic device. The communication session delivery system may redirect the communication session to a second domain associated with installation of applications for the personal electronic device and restrict the communication session to the first domain, the second domain, and a third domain associated with an application server for the application based on redirecting the communication session to the second domain.

### CROSS REFERENCE

The present Application is a 371 national phase filing of International Patent application No. PCT/US2022/043873 by MURRAY et al., entitled “PROVIDING COMMUNICATION SESSIONS BASED ON MOBILE APPLICATION ENGAGEMENT” filed Sep. 16, 2022, and to U.S. Provisional Patent Application No. 63/245,493 by MURRAY et al., entitled “PROVIDING COMMUNICATION SESSIONS BASED ON MOBILE APPLICATION ENGAGEMENT,” filed Sep. 17, 2021, each of which are assigned to the assignee hereof, and each of which are expressly incorporated by reference in its entirety herein.

### BACKGROUND

The following relates generally to communication session delivery systems, and more specifically to techniques for providing communication sessions based on mobile application engagement.

Increasingly, passengers on commercial aircraft or other transit vehicles such as buses, trains, boats, and the like, desire broadband network access while in transit. Additionally, passenger vehicles often include vehicle information systems to satisfy the desire of the passenger to access viewing content, such as entertainment, information content or other viewing content, while on the move. Passenger aircraft may receive network access service via a shared communication link such as a satellite communication link. The aircraft may have an on-board multi-user access terminal that communicates with ground stations (e.g., via a satellite of a satellite communication system) and provides network access connectivity for the passengers. For example, users may connect their communication devices (e.g., smartphones, laptops, tablets, etc.) to a wireless local area network (WLAN) served by the multi-user access terminal, which routes data communications to other networks (e.g., the Internet) via the shared communication link.

As passenger demand for broadband access and viewing content continues to evolve, operators of communication session delivery systems have devised various techniques to monetize the services in order to provide passengers reliable and pleasing experiences. However, different monetization techniques may lead to varying levels of satisfaction for the passenger. For example, separately charging passengers for access to communication sessions may lead to passenger frustration because they may feel as though the operator of the passenger vehicle is charging them for every additional service option during a trip. In view of the above, there is a need for improved communication session delivery systems associated with passenger vehicles to overcome the shortcomings of conventional communication session delivery systems.

### SUMMARY

The described techniques relate to improved methods, systems, devices, and apparatuses that support techniques for providing communication sessions based on mobile application engagement. In some examples, a communication session delivery system may provide network access service or other types of content once a passenger has completed a brand interaction. The communication session delivery system may choose from a plurality of reward offers of a plurality of reward offer types and then display the chosen offers to a passenger. The chosen offers may be selected based on profile information of a passenger and characteristics targeted by a brand partner. The passenger may then choose a reward offer and perform the required brand interaction. The brand interaction may be any number of options that a brand partner may require in exchange for access to content, such as downloading a mobile application associated with the brand partner. Completion of the brand interaction may be determined in a variety of ways including monitoring traffic from a server associated with downloading the application, or traffic between the mobile device and an application server associated with the application. Once the brand interaction has been verified, the passenger may receive the reward associated with the offer. The passenger may complete the reward, such as network access for a determined time period.

### BRIEF DESCRIPTION OF THE DRAWINGS

FIG. 1 illustrates an example of a system for wireless communications that supports techniques for providing communication sessions based on mobile application engagement in accordance with aspects of the present disclosure.

FIG. 2 illustrates an example of a system for wireless communications that supports techniques for providing communication sessions based on mobile application engagement in accordance with aspects of the present disclosure.

FIG. 3 illustrates an example process flow that supports techniques for communication sessions based on mobile application engagement in accordance with aspects of the present disclosure.

FIG. 4 illustrates an example graphical representation of a session interaction interface that supports techniques for communication sessions based on mobile application engagement in accordance with aspects of the present disclosure.

FIGS. 5 and 6 show block diagrams of devices that support techniques for communication sessions based on mobile application engagement in accordance with aspects of the present disclosure.

FIG. 7 shows a flowchart illustrating a method that supports techniques for communication sessions based on mobile application engagement in accordance with aspects of the present disclosure.

### DETAILED DESCRIPTION

A commercial passenger vehicle may support a shared communication link for network access service for passengers. For example, users may connect their communication devices to a wireless local area network (WLAN), which routes data communications to other networks (e.g., the Internet) via the shared communication link. The shared communication link may be a wireless link (e.g., cellular link, satellite communication link, etc.), and may be able to support wider bandwidth applications such as web browsing, multimedia streaming, or video communications.

Providing such network access and content services provides entertainment and comfort for a passenger during a travel segment, however, providing such services incurs costs to the travel provider. The travel provider may choose from a variety of monetization techniques in order to provide reliable and satisfactory communication session services to its passengers, including charging separate fees for chosen services, inserting ads, and the like. However, charging separate fees may lead to passenger discontentment, while inserted ads have varying levels of efficacy in user engagement.

The described features relate to a communication session delivery system which delivers communication sessions to a passenger based on completed brand interactions chosen by the passenger. Completing brand interactions chosen by the passenger may improve the experience for both the passenger and a brand partner because the passenger may engage with an interaction that he or she is most interested in, and in turn, the brand partner will have a higher value interaction with the passenger than other methods, such as untargeted ads.

Prior to or during a travel segment, brand partners or another entity may identify a number of reward offers to present to the passengers of a travel segment, where the reward offers may consist of a communication session in exchange for a passenger completing a brand interaction. A communication session delivery system may present a variety of selected reward offers of a plurality of reward offer types to a passenger through a user interface such as a portal, application, and the like. The passenger may access the user interface before and/or during the travel segment and may choose an offer.

An offer may be associated with one or more characteristics of a communication session that can be provided to the passenger for using the shared communication link upon completing interaction with the offer. The characteristic(s) of the communication session can vary from offer to offer and can be different in different examples. The characteristic(s) of the communication session may, for example, be one or more of a total amount of time allotted to the communication session, a data rate of the communication session, a total amount of data communicated during the communication session, access to one or more service types (e.g., text, email, streaming, etc.), access to one or more network destinations (e.g., a streaming video service provider, etc.), and combinations thereof.

The type of interaction to be completed by the passenger can vary from offer to offer and can be different in different examples. For example, the interaction may be completing viewing of a video associated with the offer. As another example, the example may be creating a social media post about a particular brand associated with the offer. Other example reward offer types may include buying a product or service, signing up for a service, newsletter, or the like, providing an email address, interacting with a brand's website, downloading, or engaging with a mobile application, or trying a product, service, or other offering.

Once the brand interaction has been verified, the communication session delivery system may provide the offered network access time to the passenger for use during the travel segment. The manner in which the communication session is provided to the passenger can vary between examples. In some examples, the communication session may be attributed to a user account of the passenger managed by the communication session delivery system. In such a case, the passenger may choose when to use the communication session, such as on the current travel segment and/or on different travel segments (e.g., on the same or different airlines or other transportation providers). In other examples, the communication session may be attributed to the communication device used by the passenger without requiring the passenger create a user account.

Once a brand interaction has been verified for the selected reward offer of the first group of reward offers, the communication session delivery system may record the successful interaction. The communication session delivery system may log multiple successful interactions to determine which interactions and offers users prefer. This information may be provided to brand partners in order to inform their reward offers, and travel providers may use the information to inform which reward offers they may present to passengers. Thus, the experience for both passengers and brand partners may be continually improved upon.

In some examples, devices on the transport vessel may connect to the portal associated with the transport vessel. For example, the devices (e.g., personal electronic devices) may connect (e.g., via Wi-Fi) to a multi-user access terminal on the transport vessel to establish a communication session. The multi-user access terminal may establish the communication session and may restrict the communication session initially to a first domain (e.g., the portal). The portal may present one or more reward offers to the passenger via the communications session, where the one or more reward offers relate to the communication session. The portal may receive, from the personal electronic device, an indication of selection of a first reward offer, the first reward offer associated with engagement of an application for execution on the personal electronic device of the passenger. An opportunity for installation of the application on the personal electronic device may be provided if not installed already, and installation or engagement with the application may be verified for determining completion of the brand interaction. Verifying installation or engagement may involve allowing access to one or more other domains (e.g., a second domain associated with an app store or a third domain associated with an application server), and monitoring of traffic between the personal electronic device and the second or third domains. The reward (e.g., unrestricted access to the Internet, access to IFE) associated with the brand interaction may be provided based on determining that the brand interaction has been completed.

This description provides examples, and is not intended to limit the scope, applicability, or configuration of embodiments of the principles described herein. Rather, the ensuing description will provide those skilled in the art with an enabling description for implementing embodiments of the principles described herein. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

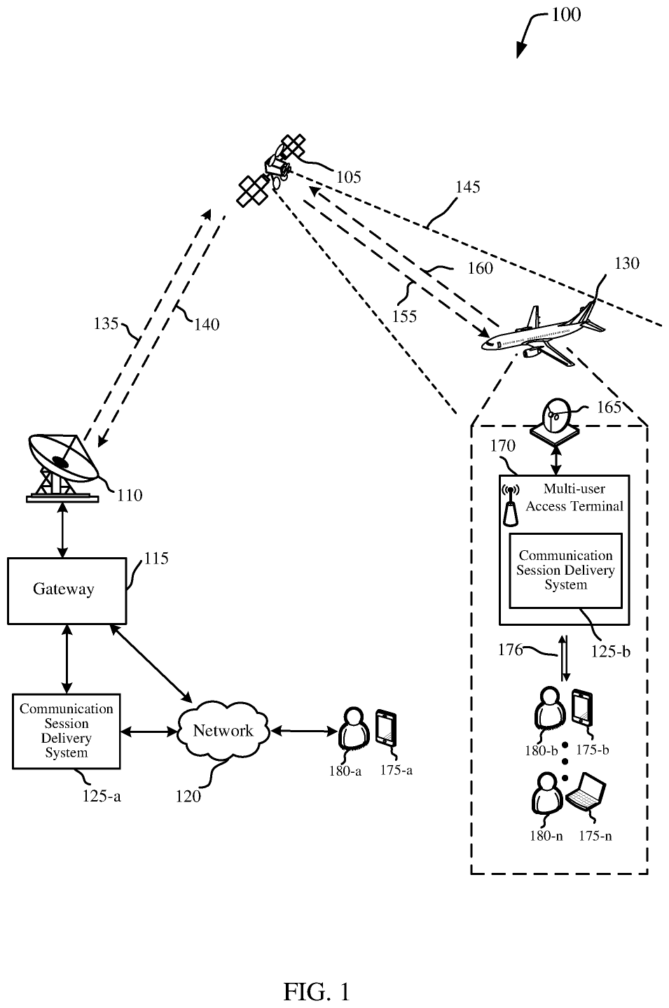

FIG. 1 is a simplified diagram of a satellite communications system 100 in which the principles included herein may be described. The satellite communications system 100 may provide network access service to passengers 180 onboard transport vessel (e.g., aircraft) 130. It should be noted that although the network access service is illustrated as being provided by a satellite communication system and used as examples in the description that follows, other and/or additional types of communication systems (e.g., an air-to-ground communication system, etc.) may be used in other examples. The network access service may be provided to passengers 180 via a multi-user access terminal 170, to which passengers 180 may connect their communication devices (e.g., mobile devices 175) via wired (e.g., Ethernet) or wireless (e.g., WLAN) connections 176. Multi-user access terminal 170 may obtain the network access service via a user beam 145. It should be noted that although transport vessel 130 is illustrated as an aircraft and aircraft are used as examples in the description that follows, references to aircraft may also be any type of transport vessel transporting multiple passengers such as buses, trains, ships, etc.

Satellite communications system 100 may include any suitable type of satellite system, including a geostationary orbit (GEO), medium earth orbit (MEO), or low earth orbit (LEO) satellite system. Although only a single user beam 145 is illustrated, satellite 105 may be a multi-beam satellite, transmitting a number (e.g., typically 20-500, etc.) of user beams 145 each directed at a different region of the earth. This can allow coverage of a relatively large geographical area and frequency re-use within the covered area. Frequency re-use in multi-beam satellite systems permits an increase in capacity of the system for a given system bandwidth. With such a multi-beam satellite, there may be a number of different signal switching configurations, allowing signals from a single gateway system 115 to be switched between different spot beams. Alternatively, multiple gateways may transmit signals to satellite 105 for generating the multiple spot beams. Although illustrated as including one satellite 105, satellite communications system 100 may include multiple satellites. The multiple satellites may have service coverage areas that at least partially overlap with each other.

Each satellite user beam 145 of satellite 105 supports transport vessel (e.g., aircraft) 130 within its coverage area (e.g., providing uplink and downlink resources). Frequency re-use between satellite user beams 145 may be provided by assigning one, or more, ranges of frequencies (which may be referred to as channels) to each satellite user beam 145 and/or by use of orthogonal polarizations. A particular frequency range and/or polarization may be called a “color,” and frequency re-use in a tiled spot beam satellite system may be according to color. The coverage of different satellite user beams 145 may be non-overlapping or have varying measures of overlap. In some examples, satellite user beams 145 of satellite 105 may be tiled and partially overlapping to provide complete or almost complete coverage for a relatively large geographical area where partially overlapping or adjacent beams use different ranges of frequencies and/or polarizations (e.g., different colors).

Satellite communications system 100 includes a gateway system 115 and a network 120, which may be connected together via one or more wired or wireless links. Gateway system 115 is configured to communicate with one or more aircraft 130 via satellite 105. Network 120 may include any suitable public or private networks and may be connected to other communications networks such as the Internet, telephony networks (e.g., Public Switched Telephone Network (PSTN), etc.), and the like. Network 120 may connect gateway system 115 with other gateway systems, which may also be in communication with satellite 105. Alternatively, a separate network linking gateways and other nodes may be employed to cooperatively service user traffic. Gateway system 115 may also be configured to receive return link signals from aircraft 130 (via the satellite 105) that are directed to a destination in network 120 or the other communication networks.

Gateway system 115 may be a device or system that provides an interface between network 120 and satellite 105. Gateway system 115 may use an antenna 110 to transmit signals to and receive signals from satellite 105 via a gateway uplink 135 and a gateway downlink 140. Antenna 110 may be two-way capable and designed with adequate transmit power and receive sensitivity to communicate reliably with satellite 105. In some examples, satellite 105 is configured to receive signals from antenna 110 within a specified frequency band and specific polarization.

In satellite communication system 100, passengers 180-b to 180-n may utilize network access service via mobile devices 175. Each passenger 180-b to 180-n may be provided service via satellite communication system 100 by connecting (e.g., via a wired or wireless connection) a mobile device 175 (e.g., desktop computer, laptop, set-top box, smartphone, tablet, Internet-enabled television, and the like) to the multi-user access terminal 170. As illustrated in FIG. 1, mobile devices 175-b to 175-n are connected via wired or wireless connections 176 (e.g., Wi-Fi, Ethernet, etc.) to multi-user access terminal 170. Multi-user access terminal 170 may receive data from satellite 105 via user beam downlink 155 and transmit data to satellite 105 via user beam uplink 160. While satellite communication system 100 is illustrated providing mobile network access service to passengers 180 aboard aircraft 130, it can be appreciated that the principles described herein for providing network access service to mobile users may be provided using multi-user access terminals positioned in fixed locations or on various modes of transportation where multiple mobile users may desire network access via satellite communications system 100 (e.g., trains, boats, buses, etc.).

Multi-user access terminal 170 may use an antenna 165 mounted on aircraft 130 to communicate signals with satellite 105 via a user beam downlink 155 and user beam uplink 160. Antenna 165 may be mounted to an elevation and azimuth gimbal which points antenna 165 (e.g., actively tracking) at satellite 105. Satellite communications system 100 may operate in the International Telecommunications Union (ITU) Ku, K, or Ka-bands (for example from 17.7 to 21.2 Giga-Hertz (GHz) in the downlink and 27.5 to 31 GHz in the uplink portion of the Ka-band). Alternatively, satellite communications system 100 may operate in other frequency bands such as C-band, X-band, S-band, L-band, and the like.

Satellite communications system 100 also includes a communication session delivery system 125. A component of communication session delivery system 125 (e.g., communication session delivery system 125-a) may be connected via one or more wired or wireless links to gateway system 115 and/or network 120. Additionally, or alternatively, there may be a component of communication session delivery system 125 (e.g., communication session delivery system 125-b) onboard aircraft 130. Although illustrated as being collocated with multi-user access terminal 170, communication session delivery system 125-b may be a separate component from multi-user access terminal 170. In that case, communication session delivery system 125-b may be connected via one or more wired or wireless links to multi-user access terminal 170.

It should be appreciated by a person skilled in the art that one or more aspects of the disclosure may be implemented in a system 100 to additionally or alternatively solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

In one example, prior to and/or during a travel segment, a travel provider (e.g., airline, cruise line, railway line, bus line) or other entity may provide profile information of one or more passengers 180 of the travel segment to communication session delivery system 125. Additionally, the travel segment communication session delivery system 125 may identify a first group of reward offers from a plurality of reward offers to present to passengers 180 of the travel segment, where the reward offers may include a communication session or other reward in exchange for a passenger 180 completing a brand interaction. The reward offers may be provided to communication session delivery system 125 by one or more brand partners. A portal (or other type of user interface) managed by (or otherwise in communication with) communication session delivery system 125 may then present a variety of selected reward offers to a passenger 180. Communication session delivery system 125 may select the first group of one or more reward offers based on, for example, the profile information of the one or more passengers 180 and/or on target characteristics specified by the brand partners, previous brand interactions between the one or more passengers 180 and the brand partners, the current travel segment, a time remaining in the travel segment, or the like. A passenger 180 may access the user interface before or during the travel segment and may choose a reward offer from the first group of one or more reward offers.

For example, passenger 180-a may access the user interface prior to the travel segment using a mobile device 175-a and connecting to network 120 through a terrestrial access point. Upon being provided a first group of one or more reward offers on the user interface, passenger 180-a may select an offer good for a certain communication session in exchange for performing a brand interaction with the offer. Once the brand interaction has been verified, communication session delivery system 125-a may enable passenger 180-a to access a communication session when he or she is aboard aircraft 130. Communication session delivery system 125-a may then provide a second group of one or more reward offers to the user interface. The second group of reward offers may not include the selected reward offer from the first group of reward offers. In some examples, the group of reward offers may not include any type of reward offers that is the same type as the selected reward offer from the first group.

The manner in which the communication session delivery system 125-a enables the passenger to access the communication session can vary. In some examples, the communication session may be attributed to a user account of the passenger managed by the communication session delivery system. In such a case, the passenger may choose when to use the communication session, such as on the current travel segment and/or on different travel segments (e.g., on the same or different airlines or other transportation providers). In other examples, the communication session may be attributed to the communication device used by the passenger without requiring the passenger create a user account.

The manner in which the communication session delivery system 125-a enables the passenger to use the communication session can vary. For example, the communication session delivery system 125-a may provide instructions to components of the satellite communications system 100 (e.g., multi-access user terminal 170, satellite 105, gateway system 115, etc.) to provision access to network 120 to provide the communication session to a communication device associated with the passenger. Passengers 180-b through 180-n onboard aircraft 130 may access the user interface prior to or during the travel segment via multi-user access terminal 170. The portal may be managed by communication session delivery system 125-b onboard aircraft 130 or by communication session delivery system 125-a outside aircraft 130.

Upon viewing of selected offers, passengers 180-b through 180-n may select an offer good for a certain communication session in exchange for performing a brand interaction. Once the brand interaction has been verified, communication session delivery system 125 may enable a respective passenger 180 to access the communication session during the travel segment. For example, communication session delivery system 125-b may maintain a list (e.g., an allow list) of devices that may be allowed to communicate to other devices or networks connected to network 120 (e.g., the Internet) and the associated durations of the communication sessions. Multi-user access terminal 170 may query the list to filter traffic coming from or going to the mobile devices. For example, multi-user access terminal 170 may maintain a network address translation table, and only devices on the list may be provided network address translation for access to networks outside of a portal, which may be served by communication session delivery system 125-b on the aircraft 130, or by a server not located on the aircraft (e.g., communication session delivery system 125-a). Communication session delivery system 125-a may indicate to communication session delivery system 125-b the identifiers (e.g., MAC addresses) of mobile devices 175 which have been granted communication sessions. In some cases, multi-user access terminal 170 may include a firewall (not shown), which may implement the allow list or network address translation according to the allow list.

In some examples, the communication session delivery system 125-a may support communication such as providing network access service for devices (e.g., mobile devices 175) within a transport vessel via a wireless communications link. The devices (e.g., personal electronic devices such as mobile devices 175) may connect to multi-user access terminal 170 to establish a communication session. The multi-user access terminal 170 may establish the communication session and may restrict the communication session initially to a first domain (e.g., to a portal of the communication session delivery system 125-a). The communication session delivery system 125-a may present, for example from, by, or using the first domain to the passenger via the communications session, one or more reward offers, the one or more reward offers related to the communication session, or an aspect thereof. The communication session delivery system 125-a may receive, from the personal electronic device, an indication of selection of a first reward offer, the first reward offer associated with engagement of an application for execution on the personal electronic device of the passenger. The communication session delivery system 125-a may support installation of the application on the personal electronic device if not installed already and may verify installation or engagement for determining completion of the brand interaction. Verifying installation or engagement may involve allowing access to one or more other domains (e.g., a second domain associated with an app store or a third domain associated with an application server), and monitoring of traffic between the personal electronic device and the second or third domains. The communication session delivery system 125-a may provide the reward (e.g., unrestricted access to the Internet, access to IFE) associated with the brand interaction based on determining that the brand interaction has been completed.

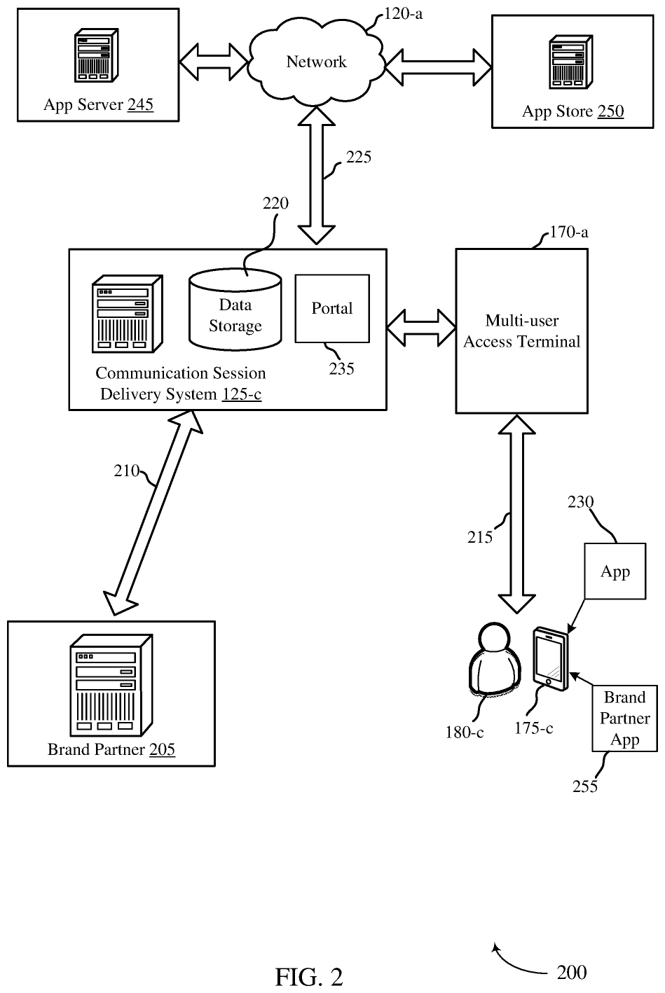

FIG. 2 illustrates an example of a system 200 that supports techniques for providing in-flight communication sessions in accordance with aspects of the present disclosure. System 200 includes communication session delivery system 125-c, brand partner 205, network 120-a, multi-user access terminal 170-a, and mobile device 175-c operated by passenger 180-c. Brand partner 205 and communication session delivery system 125-c may include or utilize various computing components such as data servers and/or data storage systems for facilitating and maintaining communications and supporting offers to facilitate brand interactions and other services. Brand partner 205 may also represent a plurality of affiliated or non-affiliated brand partners. Communication session delivery system 125-c may be an example of a communication session delivery system 125 of FIG. 1. Mobile device 175-c and passenger 180-c may be examples of mobile device 175 and passenger 180 of FIG. 1, respectively.

The entities of system 200 transmit various communication messages between each other, including bidirectional communication 210, bidirectional communication 215, and bidirectional communication 225. For example, bidirectional communication 210 may include brand partner 205 sending one or more reward offers to communication session delivery system 125-c for eventual presentation to passenger 180-c. Each of the reward offers may be linked to one or more target characteristics that a brand partner may wish to focus its reward offer towards. For example, if the reward offer is tailored to a specific gender, a brand partner may indicate that the reward offer's target characteristic is either male or female. In some examples, communication session delivery system 125-c may retrieve reward offers from data storage 220 or from network 120-a via bidirectional communication 225.

A reward offer may include a communication session that is awarded to a passenger when the passenger completes a specified brand interaction. A communication session may be network access service for at least a portion of the travel segment, access to a media content item (e.g., visual media, audio media, games, etc.), or a combination thereof. Access to media content items may also be referred to as in-flight entertainment (IFE). IFE may be hosted on the aircraft and may include content that is otherwise unavailable (e.g., pre-release movies that have not yet become available for streaming). Brand interactions may be categorized as a media item (e.g., displayed advertisement, promotional video), a social media interaction (e.g., a post mentioning the brand), a creation of a user account, a purchase of a good or service, a completion of a survey, a reservation of a good or service, an indication of interest in a good or service (e.g., submitting a positive feedback of the good or service, placing the good or service in a virtual cart, etc.), a purchase of a good or service, providing an email address, trying out a product or service, browsing a brand partner's website, downloading or engaging with an application, or a combination thereof.

Communication session delivery system 125-c may receive profile information of one or more passengers and/or of a travel segment from network 120-a via bidirectional communication 225 or from data storage 220. In some examples, a travel provider of the travel segment may update communication session delivery system 125-c with the passengers' profile information either periodically or aperiodically via bidirectional communication 225. The profile information may include any information that the travel provider may possess regarding a passenger and characteristics of the travel segment that the passenger is booked for. For example, the profile information may include user characteristics such as gender, age, originating/destination location, type of traveler (business, pleasure, etc.), frequency of travel, traveling with a family or group, class of travel for a passenger, previous brand interactions, etc. In another example, the characteristics of the travel segment may include an origin of the travel segment, a destination of the travel segment, respective passenger classes for passengers, a duration of the travel segment, or a type of vessel for the travel segment.

System 200 may include a multi-user access terminal 170-a, which may be an example of the multi-user access terminal 170 of FIG. 1. Multi-user access terminal 170-a may be located on an aircraft and may allow mobile devices 175 to establish communication sessions via a communication link from the aircraft to a ground station (e.g., via a satellite communication system as described in FIG. 1).

Communication session delivery system 125-c may include portal 235, which may be an initial landing page for mobile devices 175 that establish a communication session with multi-user access terminal 170-a. For example, a mobile device 175-c may establish a communication session with multi-user access terminal 170-a (e.g., via a Wi-Fi access point), and multi-user access terminal 170-a may restrict the communication session to have access to only portal 235 (e.g., using an allow list). In some cases, multi-user access terminal 170-a may include a firewall (not shown), which may implement the allow list according to MAC addresses of the mobile devices 175. Portal 235 may be located on the aircraft (e.g., hosted by multi-user access terminal 170-a), or may be located within a ground system of communication session delivery system 125-c. Thus, when mobile device 175-c initially establishes a connection with multi-user access terminal 170-a, mobile device 175-c may be directed to retrieve initial content to display to passenger 180-c from portal 235.

Communication session delivery system 125-c may aggregate the one or more reward offers from brand partner 205 with other reward offers from other brand partners to obtain a pool of reward offers for the travel segment. In some cases, communication session delivery system 125-c may apply a scarcity factor to the pool of reward offers (e.g., may determine the pool of reward offers based on the scarcity factor). Communication session delivery system 125-c may apply a scarcity factor to the pool of reward offers in order to introduce an artificial limitation upon the pool of reward offers on a per-passenger basis. This artificial limitation of the pool of reward offers may be utilized to induce competition or feelings of scarcity for reward offers, which may result in heightened urgency for passengers 180 in claiming reward offers. The scarcity factor may involve limiting the supply of the reward offers (e.g., such that a passenger may not be able to obtain enough reward offers to obtain communication sessions lasting the duration of the flight), limiting the amount of time a reward offer is available, or similar techniques for introducing urgency.

In some cases, communication session delivery system 125-c may determine the scarcity factor based on one or more known or expected characteristics (e.g., quantity of passengers, duration of travel segment, aggregate number of access minutes, etc.) of the travel segment when selecting the pool of rewards offers or the first, second, or later groups of reward offers. For example, the scarcity factor may be chosen such that the number of reward offers in the pool is proportional to the total number of passengers on the travel segment (e.g., if one hundred passengers are expected for a travel segment, communication session delivery system 125-c may only offer the number of communication sessions equal to half—or some other multiple—of the quantity of passengers). In another example, communication session delivery system 125-c may only offer a predetermined amount of time corresponding to the pool of rewards. In some examples, communication session delivery system 125-c may also determine the scarcity factor by factoring a total duration of a travel segment and/or a quantity of passengers of the travel segment. For example, communication session delivery system 125-c may only offer 1000 aggregate minutes of network access to all passengers for the travel segment, where the aircraft may have 100 passengers for the travel segment and the travel segment may be one hour long. That is, communication session delivery system 125-c may determine a total number of passenger minutes based on the quantity of passengers (e.g., a passenger capacity of the aircraft or a quantity of booked passengers) and the duration of the travel segment (e.g., gate-to-gate duration, flight duration, or duration of communications taking into account device restrictions during the flight). Communication session delivery system 125-c may then determine the aggregate minutes of network access to be offered based on the total number of passenger minutes and a scarcity factor. A value of the scarcity factor applied to the reward offers may be presented to the passengers along with the associated reward offers. Application of the scarcity factor may better encourage passengers of the travel segment to engage with reward offers than if the reward offers were offered without restrictions. For example, passengers may be encouraged to engage with reward offers earlier, before the available offers are taken by other passengers or removed from the group of reward offers presented to the passenger.

With the profile information, communication session delivery system 125-c may select a first group from the pool of reward offers, where the first group may be a subset of the one or more reward offers from the pool of reward offers. Communication session delivery system 125-c may select the first group of reward offers as being tailored to a particular passenger or group of passengers of a travel segment (e.g., passenger 180-c). Communication session delivery system 125-c may choose the first group of reward offers based on the profile information of the particular passenger or group of passengers, and/or a characteristic of the particular travel segment. In some cases, communication session delivery system 125-c may determine a quantity of reward offers it will select and present to passenger 180-c based on a predetermined number, a quantity of passengers on a travel segment, a duration of the travel segment, or a maximum number of reward offers for the passengers of the travel segment. Communication session delivery system 125-c may choose a second group of reward offers based on any of the factors with which the first group is chosen and also factors including which reward offers the passenger 180-c previously selected (either on this travel segment or on other travel segments).

The one or more reward offers from brand partner 205 may each include a bid associated with the communication session. The bids may indicate a reward offer arrangement which describes a value (e.g., monetary value) that brand partner 205 may confer if its respective reward offer is selected and completed by a passenger. In some cases, communication session delivery system 125-c may select the pool of reward offers based on the bids. For example, communication session delivery system 125-c may select those rewards with the highest bids, or the rewards with the highest bids within categories of reward offers (e.g., associated with different types of brand interactions). In some examples, communication session delivery system 125-c may select a certain quantity of reward offers to be available for each of multiple types of brand interactions, and then select the rewards with the highest bids for each type.

Upon selection of the first group of reward offers, communication session delivery system 125-c may transmit the first group of reward offers over bidirectional communication 215 to a device belonging to passenger 180-c (e.g., mobile device 175-c). The first group of reward offers may be presented to the passenger 180-c via a portal 235 hosted by communication session delivery system 125-c or application 230 on mobile device 175-c. Passenger 180-c may view the first group of reward offers through the portal 235 or application 230 on mobile device 175-c either prior or during the travel segment. In some examples, mobile device 175-c may be a seat-mounted video system on board the aircraft.

Passenger 180-c may choose one or more reward offers from the first group of reward offers and may then proceed to complete a brand interaction associated with the chosen reward offer. In some examples, passenger 180-c may request that the presented first group of reward offers be changed or otherwise modified. A benefit of allowing passenger 180-c to request that the presented first group of reward offers be changed is that a first presented subset of reward offers may be unsatisfactory to passenger 180-c. Allowing modification to the first presented group of reward offers may allow passenger 180-c to discover a reward offer from a subsequent subset of reward offers (with the subsequent subset of reward offers having at least one changed presented reward offer from the first presented subset of reward offers) that may appeal to passenger 180-c. Upon receiving the request, communication session delivery system 125-c may provide a modified first group of reward offers to passenger 180-c, where the modified first group of reward offers is different from the previous subset of reward offers. Further, the second group of reward offers presented to passenger 180-c may include a different subset of reward offers which may be selected based at least in part on the first group of reward offers, a selected reward offer, and any changes requested by passenger 180-c.

When passenger 180-c selects a reward offer, mobile device 175-c may transmit an indication of the selected reward offer to portal 235 (e.g., via multi-user access terminal 170-a). In some cases, passenger 180-c may select a reward offer associated with downloading or engaging with an application 255 associated with brand partner 205. Upon receiving the indication of the selected reward offer, portal 235 may redirect the communication session to an app store 250, which may be a central location where mobile devices retrieve applications (which may be specific to a type of device of mobile devices 175). Portal 235 may also indicate to multi-user access terminal 170-a to allow mobile device 175-c to access app store 250 (e.g., by adding a domain associated with app store 250 to an allow list for mobile device 175-c). Communication session delivery system 125-c may determine whether the application has been downloaded by mobile device 175-c by monitoring traffic between the mobile device 175-c and the app store 250 to determine if the amount of traffic has exceeded a size of the application. Alternatively, portal 235 may determine whether the application 255 has been previously downloaded by mobile device 175-c.

Once the application 255 is either determined to already be present on mobile device 175-c or has been downloaded, multi-user access terminal 170-a may allow unrestricted access to domains of the Internet. As used herein, unrestricted access may mean access to all domains of the Internet, or all domains excluding domains prohibited for access using multi-user access terminal 170-a such as domains associated with illegal or prohibited activity. For example, unrestricted access may mean that the allow list is bypassed, or includes a general entry permitting access to all domains (e.g., *.*). However, multi-user access terminal 170-a may still use a block list that may block some domains for which no access is allowed. Alternatively, communication session delivery system 125-c may allow unrestricted access to domains of the Internet based on a level of engagement with the application 255. For example, communication session delivery system 125-c may monitor (e.g., via multi-user access terminal 170-a or a gateway system 115) an amount of traffic between a server 245 associated with the application 255 to determine that the level of engagement (e.g., traffic exchanged) has satisfied a threshold. Once the amount of traffic has satisfied the threshold, communication session delivery system 125-c may allow unrestricted access to the Internet. Thus, the brand interaction may be determined to be complete when the application is present on the mobile device 175-c (e.g., either previously downloaded or downloaded from app store 250), or when a level of engagement with the application is determined to reach a threshold.

Upon receiving confirmation that the brand interaction has been completed, communication session delivery system 125-c may associate the mobile device 175-c with the reward associated with the reward offer. For example, communication session delivery system 125-c may unrestrict the communication session (e.g., associate the MAC address of mobile device 175-c with unrestricted access) for a duration associated with the reward. In other examples, communication session delivery system 125-c may present a redemption code to passenger 180-c upon completion of a brand interaction where passenger 180-c may redeem the redemption code at a later time (e.g., via the same or a different device) for access to a communication session.

Upon receiving the indication, redemption code, or another indication of access, communication session delivery system 125-c may activate access to passenger 180-c to the associated reward (e.g., communication session or media experience) linked to the passenger-selected reward offer. For example, communication session delivery system 125-c may establish a communication session for mobile device 175-c via a network access device (e.g., multi-user access terminal 170-a) over a wireless communications link for a session duration associated with the reward offer. In some examples, communication session delivery system 125-c may determine an identifier of a device (e.g., MAC address) that is linked to the completed brand interaction and establish the communication session based on the identifier of the device. Under some circumstances, communication session delivery system 125-c may determine a duration of the reward and then present to mobile device 175-c a comparison of the duration to a length of time of the travel segment, where the comparison may be continually updated and presented. For example, if the reward is one hour of network access time and the remaining duration of the travel segment is two hours, mobile device 175-c may continually provide the comparison to passenger 180-c when passenger 180-c views the application 230 or portal 235.

In some examples, communication session delivery system 125-c may receive a unique identifier linked to passenger 180-c. For example, passenger 180-c may have registered a login profile with the portal 235 of communication session delivery system 125-c. In some cases, passenger 180-c may complete multiple brand interactions associated with multiple reward offers and communication session delivery system 125-c may link the multiple reward offers to the unique identifier of passenger 180-c. For example, if passenger 180-c has logged on and completed five brand interactions each worth 10 minutes of network access time, communication session delivery system 125-c may link 50 minutes of network access time to the user account of passenger 180-c. In other examples, communication session delivery system 125-c may identify one or more past brand interactions that passenger 180-c has performed under his unique identifier. With these past completed brand interactions, communication session delivery system 125-c may select reward offers from the pool of reward offers for a given travel segment to present to passenger 180-c based on the brand interaction history of passenger 180-c.

Communication session delivery system 125-c may also include data storage 220. In some examples, data storage 220 may receive and store verified completions of brand interactions for a particular travel segment. In a subsequent travel segment, communication session delivery system 125-c may receive reward offers from brand partner 205 or from other brand partners for the subsequent travel segment in a similar manner as described above. In some examples, communication session delivery system 125-c may choose the pool of reward offers for the subsequent travel segment base on the stored verified completions of brand interactions from a previous travel segment. Communication session delivery system 125-c may also choose respective subsets of the pool of reward offers for the subsequent travel segment based on profile information of the passengers of the subsequent travel segment. The profile information may similar profile information described above. The verified completions of brand interactions from the previous travel segment may better inform communication session delivery system 125-c as to which reward offers have been successful in the past.

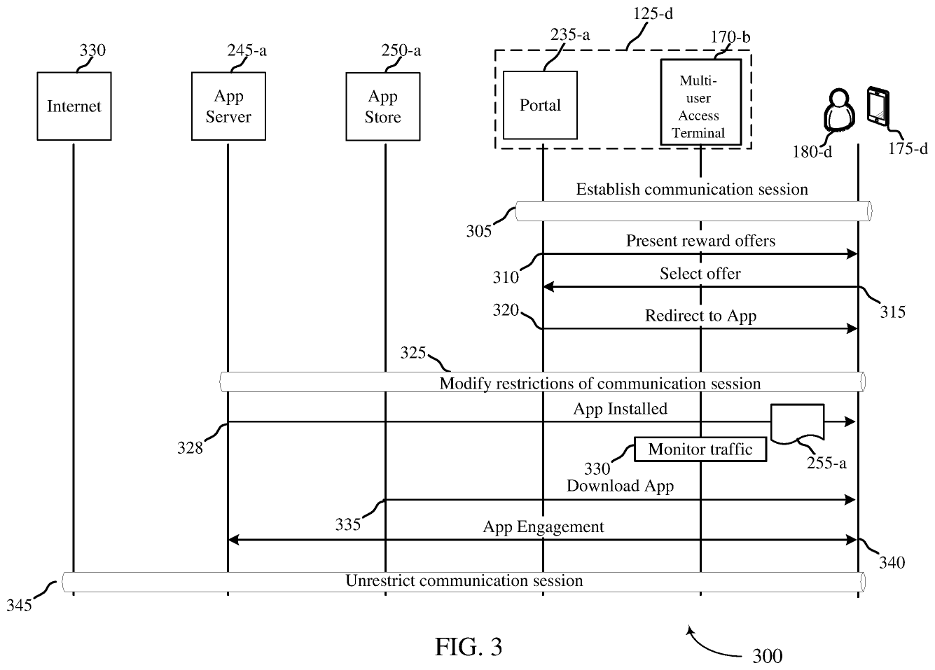

FIG. 3 illustrates an example of a process flow 300 that supports techniques for providing in-flight communication sessions in accordance with aspects of the present disclosure. The process flow may include communication session delivery system 125-d, which may include multi-user access terminal 170-b or portal 235-a, app store 250-a, app server 245-a, Internet 330, and mobile device 175-d operated by passenger 180-d. Communication session delivery system 125-d may be an example of a communication session delivery system 125 of FIG. 1 or of communication session delivery system 125-c of FIG. 2. Mobile device 175-d and passenger 180-d may be examples of mobile device 175 and passenger 180 of FIG. 1 and of mobile device 175-c and passenger 180-c of FIG. 2, respectively. Mobile device 175-d, passenger 180-c, and multi-user access terminal 170-b may be located on an aircraft, and multi-user access terminal 170-b may have a communication link to a gateway (e.g., via a satellite communication system).

At 305, the mobile device 175-d may establish a communication session with multi-user access terminal 170-b (e.g., via a Wi-Fi access point that is part of multi-user access terminal 170-b or coupled with multi-user access terminal 170-b). Multi-user access terminal 170-b may restrict the communication session to portal 235-a (e.g., a first domain). For example, multi-user access terminal 170-b may maintain an allow list for mobile device 175-d, and may initially populate the allow list only with the domain for portal 235-a. Portal 235-a may be located on the aircraft with multi-user access terminal 170-b, or may be located in a node of a network associated with communication session delivery system 125-c that is on the ground.

At 310, portal 235-a may present reward offers to passenger 180-d by sending content comprising the reward offers to mobile device 175-d. The reward offers may be associated with the brand interactions discussed above, and each reward offer may be associated with a reward, which may be related to the communication session, or an aspect thereof (e.g., related to a permitted duration, bandwidth, content type, content amount, etc., of access to the Internet 330, particular data/content sources, and so forth).

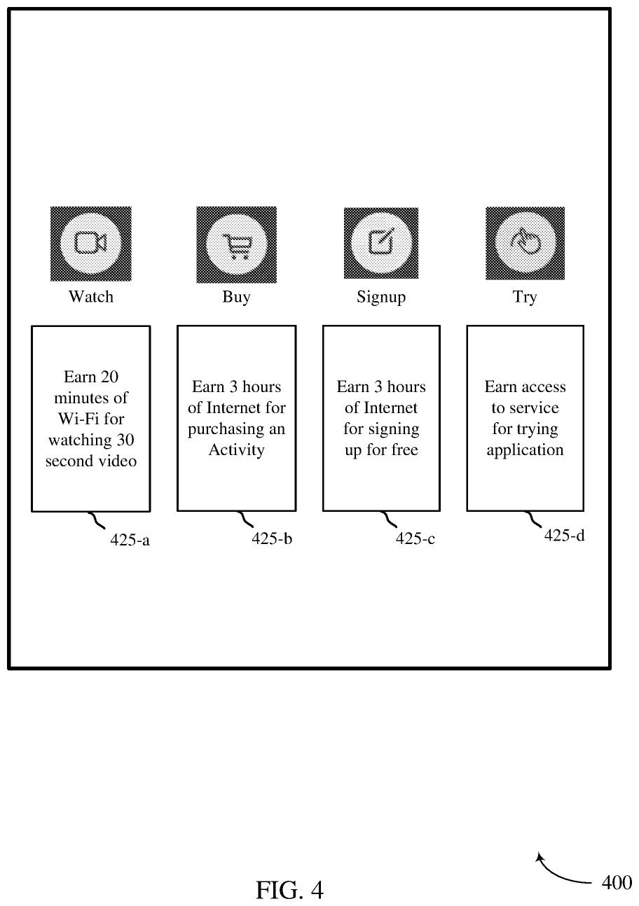

FIG. 4 illustrates an example graphical representation of a session interaction interface 400 that supports providing communication sessions based on mobile application engagement in accordance with aspects of the present disclosure. For example, portal 235-a may present multiple types of reward offers and may present one or more reward offers of each reward offer type. Reward offer type 425-a may be associated with watching an ad from a brand partner, reward offer type 425-b may be associated with purchasing a product or activity from a brand partner, reward offer type 425-c may be associated with signing up for receiving promotions from a brand partner, and reward offer type 425-d may be associated with trying an application of a brand partner on mobile device 175-d. The passenger 180-d may select a reward offer of a reward offer type 425 by pressing on a tile associated with the reward offer.

Returning to FIG. 3, the passenger 180-d may select a reward offer at 315 and portal 235-a may receive an indication of the selected reward offer. In some cases, the selected reward offer may be associated with trying an application of a brand partner on mobile device 175-d.

At 320, portal 235-a may redirect or reassociate mobile device 175-d to the application of the brand partner. In some cases, redirecting mobile device 175-d to the application may involve sending a link such as a uniform resource locator (URL) or uniform resource indicator (URI). In some cases, the link may be a universal link or application context. The link may cause the mobile device 175-d to launch the application if already installed on the mobile device 175-d or may cause the mobile device 175-d to be redirected to the app store 250-a, with a direct link (e.g., deep link) to the brand partner application on the app store. In some embodiments, the redirection or reassociation of the mobile device 175-d to the application of the brand partner is in response to the indication of the selected reward offer, where the application of the brand partner is associated with the selected reward offer.

At 325, multi-user access terminal 170-b may modify the restrictions on the communication session 305 to allow access to the app store 250-a. For example, the multi-user access terminal 170-b may add a second domain associated with the app store 250-a to the allow list associated with the mobile device 175-d. Multi-user access terminal 170-b may modify the restrictions on the communication session 305 at 325 to also allow access to a third domain associated with an application server 245-a associated with the application 255-a.

The communication session delivery system 125-d may then grant unrestricted access to the Internet 330 for the communication session 305 based on whether the application is installed or based on a certain level of engagement with the application.

For example, communication session delivery system 125-d may grant unrestricted access to the Internet 330 for the communication session 305 based on determining that the application is installed. In some cases, the communication session delivery system 125-d may determine that the application 255-a has been downloaded based on monitoring traffic between the mobile device 175-a and the app store 250-a at 330. For example, the traffic between the mobile device 175-a and the app store 250-a may be encrypted, and thus communication session delivery system 125-d may not have visibility into the content of the traffic exchanged with the app store 250-a. Thus, the communication session delivery system 125-d may monitor for a certain amount of traffic that matches a size of the application 255-a at 330. When the amount of traffic exchanged exceeds the size of the application 255-a, the communication session delivery system 125-d may determine that the application 255-a has been downloaded at 335. Alternatively, the application 255-a may be associated with an attribution function, which may determine when the application is downloaded. For example, when the link is sent to the mobile device 175-a, the mobile device's attribution function may indicate to a server (e.g., an application server 245-a associated with the application 255-a, or an attribution server) if the application was previously installed, or upon completion of the install of the application 255-a. If an attribution server is used for the attribution function, the attribution server may also be added to the allow list at 325. Thus, at 328, the application server 245-a (or an attribution server) may send an indication to communication session delivery system 125-d that the application has been installed.

Thus, at 345, the communication session delivery system 125-d may allow unrestricted access to Internet 330 for the mobile device 175-d.

In some cases, communication session delivery system 125-d may grant unrestricted access to the Internet 330 for the communication session 305 based on determining that the application is installed, and that there has been a certain level of engagement with the application. For example, communication session delivery system 125-d may also monitor traffic between the mobile device 175-d and an application server 245-a associated with the application 255-a at 330. Upon determining at 340 that a level of application engagement has satisfied a threshold, communication session delivery system 125-d may allow unrestricted access to Internet 330 for the mobile device 175-d at 345. In some cases, the threshold may be used to determine if the application is installed. For example, the threshold may be associated with a size of a single packet or a few packets, and thus any level of engagement may be used to determine that the application is installed because it has contacted the application server 245-a. Alternatively, the threshold may be determined based on a type of application and an amount of engagement requested by the brand partner for the reward offer. For example, the application may be a game or video content based application, and the brand partner may specify an amount of engagement as an amount of traffic exchanged in engaging with the application.

In some cases, communication session delivery system 125-d may grant unrestricted access to the Internet 330 for the communication session 305 based on a certain duration of time of engagement with the application. For example, communication session delivery system 125-d may initiate a timer upon installation of the application at 335, or upon an initialization of application engagement at 340 (e.g., at a time when traffic is exchanged with the application server 245-a). The communication session delivery system 125-d may maintain the communication session 305 as restricted to the application server 245-a, the app store 250-a, and the portal 235-a for the duration of the timer. The timer may be paused when engagement has gaps. For example, if a certain period of time has passed since a packet has been exchanged with the application server 245-a, the timer may be paused, and may resume upon a new packet being exchanged with the application server 245-a. In some cases, communication session delivery system 125-d may grant unrestricted access to the Internet 330 for the communication session 305 when either the threshold amount of traffic has been exchanged or expiration of the timer. Alternatively, communication session delivery system 125-d may grant unrestricted access to the Internet 330 for the communication session 305 when both the threshold amount of traffic has been exchanged and the timer has expired.

In some cases, when the communication session 305 is restricted, the communication session delivery system 125-d may limit the amount of traffic that can be exchanged with the app store 250-a to keep the passenger 180-d from downloading additional applications. For example, communication session delivery system 125-d may monitor traffic between the mobile device 175-d and the app store 250-a and may restrict communication session 305 from access to the app store 250-a (e.g., removing the app store 250-a from the allow list), if the amount of traffic between the mobile device 175-d and the app store 250-a exceeds the size of the application by more than a threshold. Additionally, or alternatively, communication session delivery system 125-d may limit the amount of time that mobile device 175-d may be able to access the app store 250-a. For example, communication session delivery system 125-d may start a timer when the mobile device 175-d is redirected to the app store 250-a and may restrict communication session 305 from access to the app store 250-a upon expiration of the timer. In some cases, the timer may be paused when traffic is present between mobile device 175-d and app store 250-a (to keep from removing access to the app store 250-a if the download of the application 255-a is in progress). In some cases, a duration of the timer may be determined based on a network speed for the communication session and a size of the application (e.g., to ensure that the application will have time to download).

In some embodiments, the one or more of the presented reward offers may include or otherwise indicate an associated brand interaction. In some embodiments, the associated brand interaction may involve the passenger 180-d providing account information (or similar information) that enables the portal 235-a to verify an existing relationship of the passenger 180-d. In some instances, the passenger 180-d may provide account information to complete the associated brand interaction, which the portal 235-a may use to authorize a reward session based on a relationship, status, etc., of the passenger 180-d, such as one or more of a loyalty status, cell phone plan, home internet plan, and so forth). For example, where the passenger 180-d has a cell phone plan that permits or includes free internet access of aircraft travel, the passenger 180-d may provide corresponding account information that the portal 235-a uses to verify with the cell phone plan provider to authorize such access. Based on authorizing the access permitted to the passenger 180-d, the passenger 180-d may be provided with an unrestricted communication session at 345. Similarly, the portal 235-a may determine whether the passenger 180-d is permitted to access one of a number of restricted or unrestricted communication sessions as may be appropriate with associations with the provided account information (such as time limited access, content limited access, and so forth).

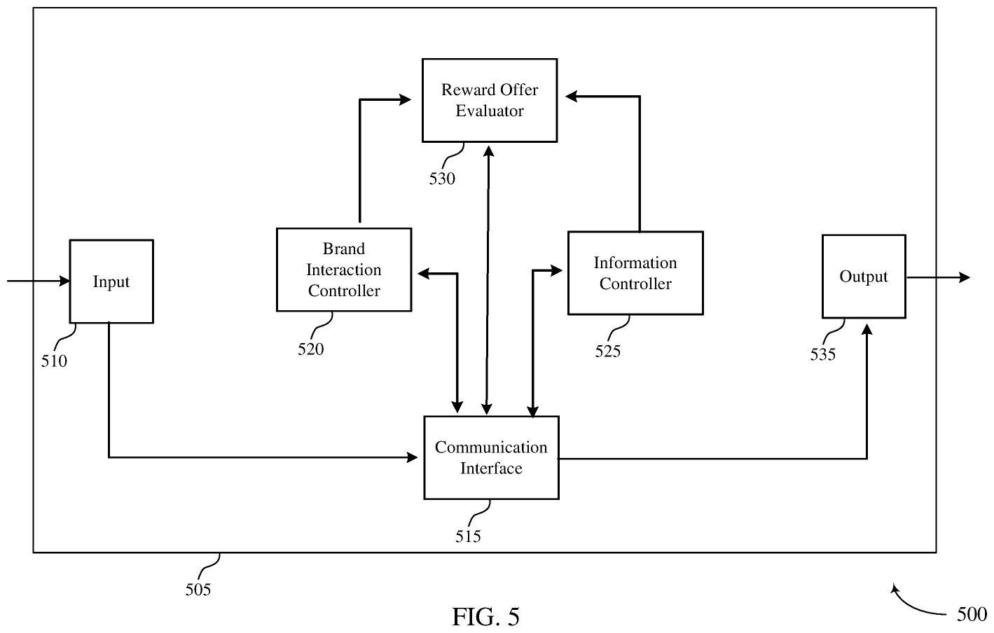

FIG. 5 shows a block diagram 500 of an apparatus 505 that supports techniques for providing communication sessions based on mobile application engagement in accordance with aspects of the present disclosure. In some examples, apparatus 505 may be an example of a communication session delivery system 125 of FIGS. 1, 2, and 3. The apparatus 505 may include an input module 510, a communication interface 515, a brand interaction controller 520, an information controller 525, a reward offer evaluator 530, and an output module 535. The apparatus 505 may also include a processor. The components may communicate via one or more buses.

The apparatus 505 and/or at least some of its various sub-components may be implemented in hardware, software executed by a processor, firmware, or any combination thereof. If implemented in software executed by a processor, the functions of the apparatus 505 and/or at least some of its various sub-components may be executed by a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described in the present disclosure. The apparatus 505 and/or at least some of its various sub-components may be physically located at various positions, including being distributed such that portions of functions are implemented at different physical locations by one or more physical devices. In some examples, the apparatus 505 and/or at least some of its various sub-components may be a separate and distinct component in accordance with various aspects of the present disclosure. In other examples, the apparatus 505 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

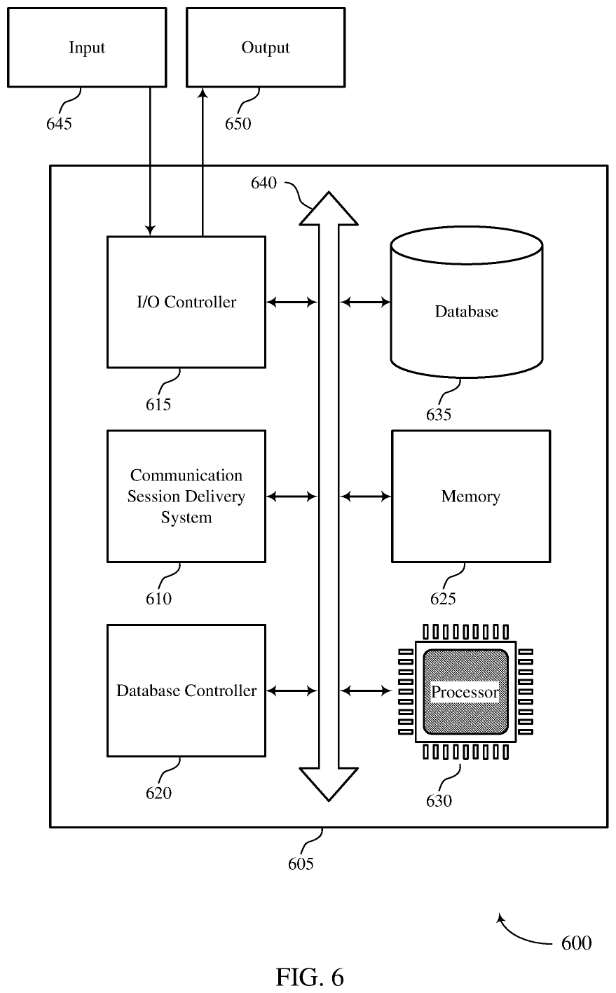

The input module 510 may manage input signals for the apparatus 505. For example, the input module 510 may identify input signals associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the apparatus 505 for processing. In some cases, the input module 510 may be a component of an input/output (I/O) controller 615 as described with reference to FIG. 6.

The communication interface 515 may serve as an interface between various modules of the apparatus 505, for example, the brand interaction controller 520, the information controller 525, and the reward offer evaluator 530, and input module 510 and output module 535.

The communication interface 515 may support communication within a transport vessel served via a wireless communications link in accordance with examples as disclosed herein. The communication interface 515 may be configured as or otherwise support a means for establishing, by a multi-user access terminal on the transport vessel, a communication session with a personal electronic device of a passenger on the transport vessel, the communication session restricted to a first domain. The reward offer evaluator 530 may be configured as or otherwise support a means for presenting, from the first domain to the passenger via the communications session, one or more reward offers, the one or more reward offers related to the communication session. The brand interaction controller 520 may be configured as or otherwise support a means for receiving, from the personal electronic device, an indication of selection of a first reward offer, the first reward offer associated with engagement of an application for execution on the personal electronic device of the passenger. In some examples, the communication interface 515 may be configured as or otherwise support a means for redirecting the communication session to a second domain, the second domain associated with installation of applications for the personal electronic device. In some examples, the communication interface 515 may be configured as or otherwise support a means for restricting the communication session to the first domain, the second domain, and a third domain associated with an application server for the application based on redirecting the communication session to the second domain.

In some examples, the brand interaction controller 520 may be configured as or otherwise support a means for comparing an amount of traffic communicated between the second domain and the personal electronic device to a size of the application.

In some examples, the information controller 525 may be configured as or otherwise support a means for restricting the communication session to the first domain based on determining that the amount of traffic communicated between the second domain and the personal electronic device has exceeded the size of the application by a threshold.

In some examples, the information controller 525 may be configured as or otherwise support a means for initiating a timer upon redirecting the communication session to the second domain. In some examples, the information controller 525 may be configured as or otherwise support a means for restricting the communication session to the first domain based on determining that the amount of traffic communicated between the second domain and the personal electronic device is less than the size of the application upon expiration of the timer.

In some examples, the brand interaction controller 520 may be configured as or otherwise support a means for determining a duration of the timer based on a network speed associated with the communication session and a size of the application.

In some examples, the information controller 525 may be configured as or otherwise support a means for unrestricting the communication session based on determining that the amount of traffic communicated between the second domain and the personal electronic device has exceeded the size of the application.

In some examples, the information controller 525 may be configured as or otherwise support a means for comparing an amount of traffic communicated between the personal electronic device and the third domain to a threshold. In some examples, the information controller 525 may be configured as or otherwise support a means for unrestricting the communication session based on determining that the amount of traffic communicated between the personal electronic device and the third domain has exceeded the threshold.

In some examples, the information controller 525 may be configured as or otherwise support a means for unrestricting the communication session based on receiving an indication that the application has been installed on the personal electronic device.

In some examples, to support redirecting the communication session to the second domain, the communication interface 515 may be configured as or otherwise support a means for sending a context for the application to the personal electronic device.

In some examples, the information controller 525 may be configured as or otherwise support a means for unrestricting the communication session based on determining that the application has been previously installed on the personal electronic device.

In some examples, communication between the personal electronic device and the second domain is encrypted.

In some examples, restricting the communication session to the first domain, the second domain, and the third domain includes providing an allow list associated with the personal electronic device to a firewall for the wireless communication link. In some examples, the allow list includes the first domain, the second domain, and the third domain.

FIG. 6 shows a diagram of a system 600 including a device 605 that supports techniques for providing communication sessions based on mobile application engagement in accordance with aspects of the present disclosure. The device 605 may be an example of or include the components of a communication session delivery system 125 or apparatus as described herein. The device 605 may include components for bi-directional data communications including components for transmitting and receiving communications, including a communication session delivery system 610, an I/O controller 615, a database controller 620, memory 625, a processor 630, and a database 635. These components may be in electronic communication via one or more buses (e.g., bus 640).

The communication session delivery system 610 may be an example of a communication session delivery system 125 as described herein. In some cases, the communication session delivery system 610 may be implemented in hardware, software executed by a processor, firmware, or any combination thereof.

The I/O controller 615 may manage input signals 645 and output signals 650 for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The database controller 620 may manage data storage and processing in a database 635. In some cases, a user may interact with the database controller 620. In other cases, the database controller 620 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause the processor to perform various functions described herein. In some cases, the memory 625 may contain, among other things, a basic input/output system (BIOS) which may control basic hardware or software operation such as the interaction with peripheral components or devices.

The processor 630 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in a memory 625 to perform various functions.

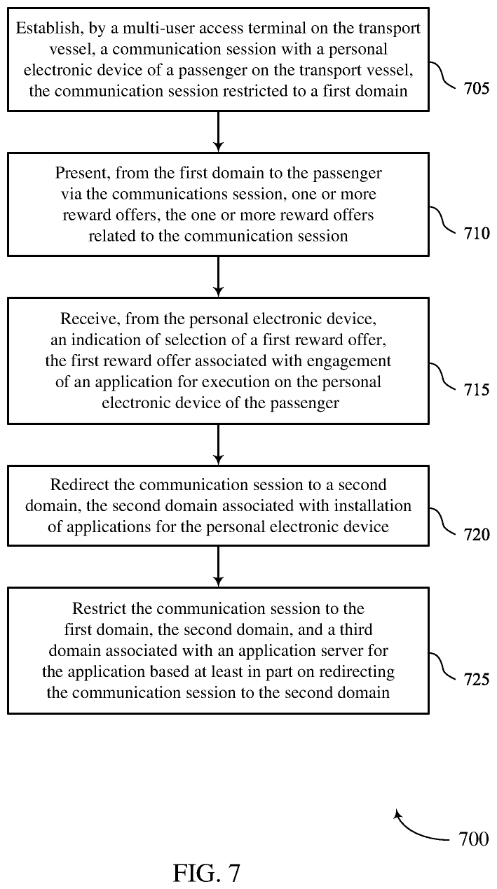

FIG. 7 shows a flowchart illustrating a method 700 that supports techniques for providing communication sessions based on mobile application engagement in accordance with aspects of the present disclosure. The operations of method 700 may be implemented by a communication session delivery system or its components as described herein. For example, the operations of method 700 may be performed by a communication session delivery system as described with reference to FIGS. 1 through 6. In some examples, a communication session delivery system may execute a set of instructions to control the functional elements of the communication session delivery system to perform the functions described herein. Additionally, or alternatively, a communication session delivery system may perform aspects of the functions described herein using special-purpose hardware.

At 705, the method may include establishing, by a multi-user access terminal on the transport vessel, a communication session with a personal electronic device of a passenger on the transport vessel, the communication session restricted to a first domain. The operations of 705 may be performed in accordance with examples as disclosed herein. In some examples, aspects of the operations of 705 may be performed by a communication interface 515 as described with reference to FIG. 5.

At 710, the method may include presenting, from the first domain to the passenger via the communications session, one or more reward offers, the one or more reward offers related to the communication session. The operations of 710 may be performed in accordance with examples as disclosed herein. In some examples, aspects of the operations of 710 may be performed by a reward offer evaluator 530 as described with reference to FIG. 5.

At 715, the method may include receiving, from the personal electronic device, an indication of selection of a first reward offer, the first reward offer associated with engagement of an application for execution on the personal electronic device of the passenger. The operations of 715 may be performed in accordance with examples as disclosed herein. In some examples, aspects of the operations of 715 may be performed by a brand interaction controller 520 as described with reference to FIG. 5.

At 720, the method may include redirecting the communication session to a second domain, the second domain associated with installation of applications for the personal electronic device. The operations of 720 may be performed in accordance with examples as disclosed herein. In some examples, aspects of the operations of 720 may be performed by a communication interface 515 as described with reference to FIG. 5.

At 725, the method may include restricting the communication session to the first domain, the second domain, and a third domain associated with an application server for the application based on redirecting the communication session to the second domain. The operations of 725 may be performed in accordance with examples as disclosed herein. In some examples, aspects of the operations of 725 may be performed by a communication interface 515 as described with reference to FIG. 5.

It should be noted that the methods described herein describe possible implementations and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, including in the claims, a “subset” refers to one or more of a set of items. The subset may be, for example, one item of the set up to and including each item of the set.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for communication within a transport vessel served via a wireless communication link, comprising:
establishing, by a multi-user access terminal on the transport vessel, a communication session with a personal electronic device of a passenger on the transport vessel, the communication session restricted to a first domain;
presenting, from the first domain to the passenger via the communication session, one or more reward offers;
receiving, from the personal electronic device, an indication of selection of a first reward offer, the first reward offer associated with engagement of an application for execution on the personal electronic device of the passenger;
redirecting the communication session to a second domain, the second domain associated with installation of applications for the personal electronic device; and
restricting the communication session to the first domain, the second domain, and a third domain associated with an application server for the application based at least in part on redirecting the communication session to the second domain.

2. The method of claim 1, further comprising:
comparing an amount of traffic communicated between the second domain and the personal electronic device to a size of the application.

3. The method of claim 2, further comprising:
restricting the communication session to the first domain based at least in part on determining that the amount of traffic communicated between the second domain and the personal electronic device has exceeded the size of the application by a threshold.

4. The method of claim 2, further comprising:
initiating a timer upon redirecting the communication session to the second domain; and
restricting the communication session to the first domain based at least in part on determining that the amount of traffic communicated between the second domain and the personal electronic device is less than the size of the application upon expiration of the timer.

5. The method of claim 4, further comprising:
determining a duration of the timer based at least in part on a network speed associated with the communication session and a size of the application.

6. The method of claim 2, further comprising:
unrestricting the communication session based at least in part on determining that the amount of traffic communicated between the second domain and the personal electronic device has exceeded the size of the application.

7. The method of claim 1, further comprising:
comparing an amount of traffic communicated between the personal electronic device and the third domain to a threshold; and
unrestricting the communication session based at least in part on determining that the amount of traffic communicated between the personal electronic device and the third domain has exceeded the threshold.

8. The method of claim 1, further comprising:
unrestricting the communication session based at least in part on receiving an indication that the application has been installed on the personal electronic device.

9. The method of claim 1, wherein redirecting the communication session to the second domain comprises:
sending a context for the application to the personal electronic device.

10. The method of claim 1, further comprising:
unrestricting the communication session based at least in part on determining that the application has been previously installed on the personal electronic device.

11. The method of claim 1, wherein communication between the personal electronic device and the second domain is encrypted.

12. The method of claim 1, wherein:
restricting the communication session to the first domain, the second domain, and the third domain comprises providing an allow list associated with the personal electronic device to a firewall for the wireless communication link, and
the allow list includes the first domain, the second domain, and the third domain.

13. An apparatus for providing communication sessions within a transport vessel served via a wireless communication link, comprising:
a communication interface configured to establish, by a multi-user access terminal on the transport vessel, a communication session with a personal electronic device of a passenger on the transport vessel, the communication session restricted to a first domain;
a reward offer evaluator configured to present, from the first domain to the passenger via the communication session, one or more reward offers; and
a brand interaction controller configured to receive, from the personal electronic device, an indication of selection of a first reward offer, the first reward offer associated with engagement of an application for execution on the personal electronic device of the passenger,
wherein the communication interface is further configured to redirect the communication session to a second domain, the second domain associated with installation of applications for the personal electronic device, and
wherein the communication interface is further configured to restrict the communication session to the first domain, the second domain, and a third domain associated with an application server for the application based at least in part on redirecting the communication session to the second domain.

14. The apparatus of claim 13, the brand interaction controller further configured to:
compare an amount of traffic communicated between the second domain and the personal electronic device to a size of the application.

15. The apparatus of claim 14, further comprising:
an information controller configured to restrict the communication session to the first domain based at least in part on determining that the amount of traffic communicated between the second domain and the personal electronic device has exceeded the size of the application by a threshold.

16. The apparatus of claim 15, wherein the information controller is further configured to:
initiate a timer upon redirecting the communication session to the second domain; and
restrict the communication session to the first domain based at least in part on determining that the amount of traffic communicated between the second domain and the personal electronic device is less than the size of the application upon expiration of the timer.

17. The apparatus of claim 16, wherein the brand interaction controller is further configured to:
determine a duration of the timer based at least in part on a network speed associated with the communication session and a size of the application.

18. The apparatus of claim 14, further comprising an information controller configured to:
unrestrict the communication session based at least in part on determining that the amount of traffic communicated between the second domain and the personal electronic device has exceeded the size of the application.

19. The apparatus of claim 13, further comprising an information controller configured to:
compare an amount of traffic communicated between the personal electronic device and the third domain to a threshold; and
unrestrict the communication session based at least in part on determining that the amount of traffic communicated between the personal electronic device and the third domain has exceeded the threshold.

20. The apparatus of claim 13, further comprising an information controller configured to:
unrestrict the communication session based at least in part on receiving an indication that the application has been installed on the personal electronic device.

21. The apparatus of claim 13, the communication interface further configured to:
send a context for the application to the personal electronic device.

22. The apparatus of claim 13, further comprising an information controller configured to:
unrestrict the communication session based at least in part on determining that the application has been previously installed on the personal electronic device.

23. The apparatus of claim 13, wherein communication between the personal electronic device and the second domain is encrypted.

24. The apparatus of claim 13, wherein restricting the communication session to the first domain, the second domain, and the third domain comprises providing an allow list associated with the personal electronic device to a firewall for the wireless communication link, wherein the allow list includes the first domain, the second domain, and the third domain.
